(19) United States
(12) Patent Application Publication
(10) Pub. No.: US 2017/0321624 A1
(43) Pub. Date: Nov. 9, 2017

(54) PISTON FOR AN ENGINE

(71) Applicant: Ning TAO, Beijing (CN)

(72) Inventors: Ning TAO, Beijing (CN); Shaoping WANG, Madison, WI (US)

(21) Appl. No.: 15/534,506

(22) PCT Filed: Jun. 25, 2015
(86) PCT No.: PCT/CN2015/082305

§ 371 Date: Jul. 18, 2017

(30) Foreign Application Priority Data
Dec. 12, 2014 (CN) 201410759479.7

(51) Int. Cl. F02F 3/02; F16J 1/08

(52) U.S. Cl. CPC F02F 3/02; F16J 1/08

(57) ABSTRACT

The present invention discloses a piston for an engine. The piston comprises a piston body; wherein, a top land, a first compression ring groove, a second land, a second compression ring groove, a third land, an oil ring groove are disposed in turn on the periphery of the piston body from top to bottom; the ratio of the depth of the first compression ring groove to the depth of the second compression ring groove is less than or equal to 1.0; at least one of annular expansion grooves are disposed on the periphery of the second land and/or the third land, to reduce the intra-cylinder carbon deposition and the hydrocarbon emissions in the exhaust gas emissions of the engine and thus improve the engine efficiency and the overall performance of the engine.

### TECHNICAL FIELD OF THE INVENTION

The present invention relates to the field of engine parts and fittings and in particular to an engine piston.

### BACKGROUND OF THE INVENTION

The regulations for the emission control of engines are getting more and more rigorous. For a piston (the piston assembly consisting of the piston and a piston ring set) which is one of key components for an engine, the structural design of its body has great influence on the amount of the unburned hydrocarbons in the exhaust emissions. Firstly, during the exhaust process of an engine cycle, part of the unburned hydrocarbons in a crevice between the piston and the piston rings as well as a crevice between the piston and the cylinder bore wall (mainly a crevice above a first compression piston ring and a part of a crevice between the first compression piston ring and a second compression piston ring) will escape from an exhaust valve together with the burnt gas. Secondly, during the compression, ignition and expansion processes of an engine cycle, part of the unburned high-pressure fuel-air mixture and the burned high-temperature and high-pressure gas enter the crankcase of the engine through the crevices between the piston and the piston rings as well as the crevices between the piston and the cylinder bore due to a large difference in pressure, so that the blow-by gas leakage of the unburned fuel-air mixture and the burned gas is caused. The blow-by gas leakage generally will result in the rise of temperature and pressure of the oil in the crankcase so as to form oil vapor. The oil vapor, together with the blow-by gas of the unburned fuel-air mixture and the burned gas, enters the breather system of the engine. Part of the oil vapor will enter the combustion chamber to participate in combustion to form unburned hydrocarbon emissions which are exhausted out from the exhaust valve along with the burnt gas. Thirdly, the sustained combustion of the engine oil will form carbon deposition on the top of the piston and on the surface of the combustion chamber. The formation of the carbon deposition will provide a hotbed for unburned hydrocarbons, and the unburned hydrocarbons hidden in the carbon deposition will escape from the exhaust valve together with the burnt gas during the exhaust process. Apparently, the amount of blow-by gas leakage of the unburned fuel-air mixture and the burned gas has a non-negligible and direct impact on the hydrocarbon emissions.

In an existing engine, since the piston is of a structure having an equal land diameter and an equal groove depth, a crevice passage formed by a piston, a corresponding piston ring set and a cylinder bore wall is unable to generate high enough flow resistance and high energy dissipation due to the lack of significant multi-stage suddenly-converged and suddenly-enlarged features, it is very difficult to avoid a large amount of blow-by gas leakage of the unburned high-pressure fuel-air mixture and the burned high-temperature and high-pressure gas, and the effect is limited even if various methods for reducing the crevices are tried.

Chinese Patent Application 201210555032.9 disclosed a piston for a supercharged engine, wherein an annular relief groove (having a cross-section in an unsealed P-shape) is provided on a second land to reduce the amount of blow-by leakage. Although this works well in reducing the amount of blow-by leakage to a certain extent, the shortcoming is that the effect of the disclosed single P-shaped relief groove is limited. Especially, its unsealed P-shaped cross-section design will result in lower than expected flow resistance. As a result, part of the kinetic energy and momentum of the high-speed blow-by gas cannot be effectively dissipated and instead is directly converted into pressure energy. Thus, part of the blow-by gas still has enough energy and momentum to run into the crankcase.

### SUMMARY OF THE INVENTION

A technical problem mainly to be solved by the present invention is to provide an engine piston. The structure of the piston, together with a piston ring set and a cylinder bore wall both matched to the piston, forms a special crevice passage with a multistage throttling and expansion function. The crevice passage will generate high enough flow resistance in the compression, ignition and expansion processes of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The engine piston of the present invention can not only greatly and effectively reduce the intra-cylinder carbon deposition and the hydrocarbon emissions in the exhaust gas emissions of the engine, but also significantly improve the engine efficiency and the overall performance of the engine, so that the present invention is suitable for wide applications.

To solve the technical problem, a engine piston is provided, the piston comprises a piston body; wherein a top land, a first compression ring groove, a second land, a second compression ring groove, a third land, an oil ring groove are disposed in turn on the periphery of the piston body from top to bottom; and at least one annular expansion groove is disposed on the periphery of the second land.

As a preferred embodiment of the present invention, at least one annular expansion grooves is further disposed on the periphery of the third land.

To solve the above mentioned technical problem, another engine piston is provided, the piston comprises a piston body, wherein a top land, a first compression ring groove, a second land, a second compression ring groove, a third land, an oil ring groove are disposed in turn on the periphery of the piston body from top to bottom; and at least one annular expansion groove is disposed on the periphery of the third land.

As a preferred embodiment of the present invention, the first compression ring groove and the second compression ring groove both have equal or unequal depths; and the first compression ring groove and the second compression ring groove have a ratio of depths less than or equal to 1.0, preferably 0.6 to 0.65.

As a preferred embodiment of the present invention, at least one annular expansion groove is disposed on the periphery of the second land and/or the third land, and a cross-section of the expansion grooves is in an arc shape, or a half-moon shape, or a U-shape having a half-moon shaped bottom, or a double-arc shape, or a double-half-moon shape, or a double-U-shape.

As a preferred embodiment of the present invention, at least one annular expansion groove is disposed on the periphery of the second land and/or the third land; a cross-section of the annular expansion grooves is in an arc shape, or a half-moon shape, or a U-shape having a half-moon shaped bottom, or a double-arc shape, or a double-half-moon shape, or a double-U-shape, and the surface of the annular expansion grooves is intersected with the surface of the corresponding second or third land to form an upper corner angle and a lower corner angle.

As a preferred embodiment of the present invention, a ratio of a width of each annular expansion groove on the second land or the third land or a sum of widths of the annular expansion grooves to a height of a corresponding second or third land is less than 1.0, preferably, 0.45 to 0.80.

As a preferred embodiment of the present invention, a ratio of the depth to the width of each annular expansion groove on the second land or the third land is less than 1.0, preferably, 0.3 to 0.5, and a cross-section of the annular expansion grooves is in an arc shape, or a half-moon shape, or a double-arc shape, or a double-half-moon shape; for annular expansion grooves having a cross-section in a U-shape or a double-U-shape, a ratio of the depth to the width is preferably 0.5 to 0.8.

As a preferred embodiment of the present invention, the first compression ring groove and the second compression ring groove both have equal or unequal widths; and the first compression ring groove and the second compression ring groove have a ratio of widths that is less than or equal to 1.0, preferably 0.6 to 1.0.

To solve the above mentioned technical problem, another engine piston is provided, the piston comprises a piston body; a top land, a first compression ring groove, a second land, a second compression ring groove, a third land, an oil ring groove are disposed in turn on the periphery of the piston body from top to bottom; the first compression ring groove and the second compression ring groove both have equal or unequal depths; the first compression ring groove and the second compression ring groove have a ratio of depths that is less than or equal to 1.0; a first annular expansion groove is disposed on the periphery of the second land, and a cross-section of the annular expansion groove is in an arc shape, or a half-moon shape, or a U-shape having a half-moon shaped bottom; and a second annular expansion groove is disposed also on the periphery of the third land, and the cross-sections of the first annular expansion groove and the second annular expansion groove are in an arc shape, or a half-moon shape, a U-shape having a half-moon shaped bottom, or a double-arc shape, or a double-half-moon shape, or a double-U-shape; wherein, the first annular expansion groove is located in the middle of the second land, with a surface of the first annular expansion groove being intersected with a surface of the second land to form a sharp corner angle; and the second annular expansion groove is located in the middle of the third land, with a surface of the second annular expansion groove being intersected with a surface of the third land to form a sharp corner angle.

The present invention has the following advantages: in the piston of the present invention, the structure of the piston, together with a piston ring set and a cylinder bore wall both matched to the piston structure, forms a special crevice passage with a multistage throttling and expansion function. The crevice passage will generate high enough flow resistance in the compression, ignition and expansion processes of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The piston of the present invention can not only greatly and effectively reduce the intra-cylinder carbon deposition and the hydrocarbon emissions in the exhaust gas emissions of the engine, but also significantly improve the engine efficiency and the overall performance of the engine, so that the engine piston of the present invention is suitable for wide applications.

### BRIEF DESCRIPTION OF THE DRAWINGS

To describe the technical solutions in the embodiments of the present invention more clearly, the accompanying drawings to be used in the description of the embodiments will be briefly described below. Apparently, the accompanying drawings described hereinafter are some of the embodiments of the present invention, and a skilled person in the art can acquire other drawings according to these drawings without any creative effort, in which:

FIG. 1 is a sectional view of a engine piston according to an embodiment of the present invention;

FIG. 2 is a partially enlarged sectional view showing the depth and structure of a first compression ring groove and of a second compression ring groove in FIG. 1;

FIG. 3 is a partially enlarged sectional view showing the arc shaped or half-moon shaped cross-section of the first annular expansion groove in FIG. 1;

FIG. 4 is a partially enlarged sectional view showing the U-shaped cross-section, having a half-moon shaped bottom, of the first annular expansion groove in FIG. 1; and

FIG. 5 is a sectional view of a engine piston according to another embodiment of the present invention;

in which:

1—piston body;

2—top land;

3—first compression ring groove;

4—second land;

5—second compression ring groove;

6—third land;

7—oil ring groove;

8—first annular expansion groove;

9—second annular expansion groove;

41—upper land angle;

42—lower land angle;

81—upper corner angle;

82—lower corner angle.

### DETAILED DESCRIPTION OF THE INVENTION

To enable a further understanding of the present invention content of the invention herein, refer to the detailed description of the invention and the accompanying drawings below. Apparently, the embodiments described herein are a part of but not all of the embodiments of the present invention. All other embodiments obtained based on the embodiments in the present invention by one person of ordinary skill in the art without any creative effort shall fall into the protection scope of the present invention.

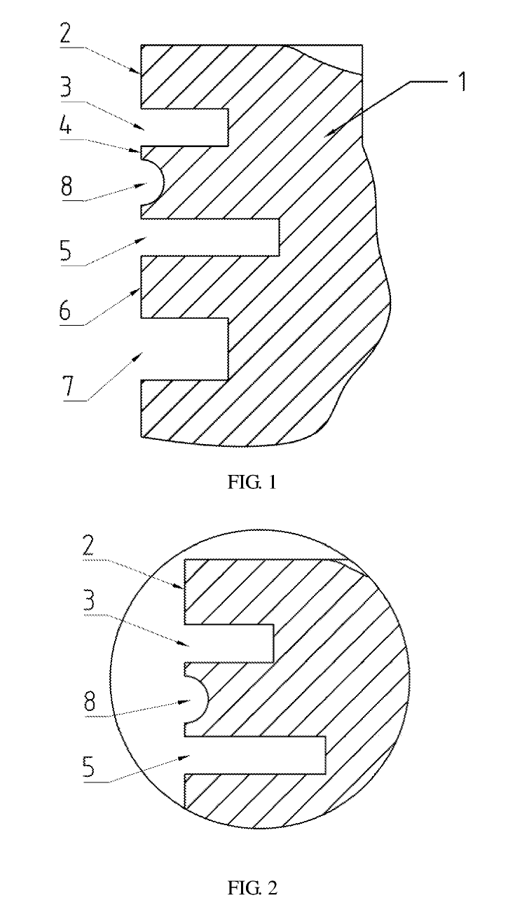

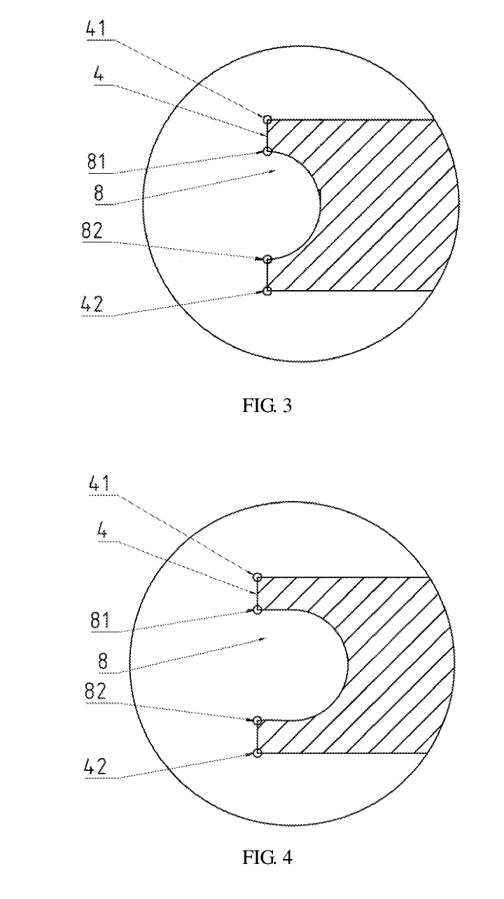

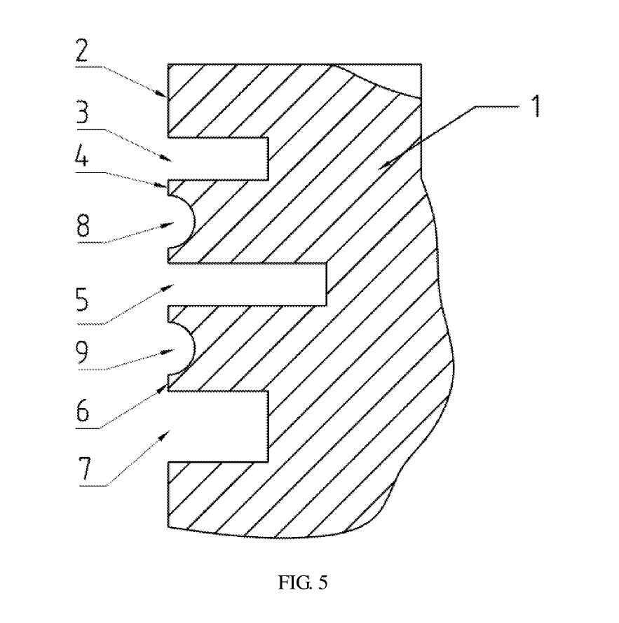

FIGS. 1-5 show a preferred embodiment of the present invention.

An engine piston comprises a piston body 1. A top land 2, a first compression ring groove 3, a second land 4, a second compression ring groove 5, a third land 6, an oil ring groove 7 are disposed in turn on the periphery of the piston body 1 from top to bottom. The first compression ring groove 3 and the second compression ring groove 5 both have equal or unequal depths. Compared with the pistons in the prior art, the depth of the first compression ring groove is reduced greatly, while the depth of the second compression ring groove is increased significantly. In the embodiment of the present invention, the ratio of the depth of the first compression ring groove 3 to the depth of the second compression ring groove 5 is less than 1.0; and a first annular expansion groove 8 is disposed on the periphery of the second land 4, and the first annular expansion groove 8 is located in the middle of the second land 4.

Wherein, the first compression ring groove 3 and the second compression ring groove 5 both have equal or unequal depths. There is a significant difference between the depth of the first compression ring groove 3 and the depth of the second compression ring groove 5. The ratio of the depth of the first compression ring groove 3 to the depth of the second compression ring groove 5 is less than 1.0. Preferably, the ratio of the depth of the first compression ring groove 3 to the depth of the second compression ring groove 5 can be 0.6 to 0.65. In other words, the first compression ring groove 3 has a depth which is 54% to 67% of the depth of the second compression ring groove 5.

Wherein, the first compression ring groove 3 and the second compression ring groove 5 both have equal or unequal widths. There is a significant difference in the width of the first compression ring groove 3 and the width of the second compression ring groove 5. The ratio of the width of the first compression ring groove 3 to the width of the second compression ring groove 5 is less than or equal to 1.0. Preferably, the ratio of first compression ring groove 3 to the width of the second compression ring groove 5 can be 0.6 to 1.0.

As described above, the first annular expansion groove 8 is located in the middle of the second land 4, and a cross-section of the first annular expansion groove 8 is in an arc shape, or a half-moon shape, or a U-shape having a half-moon shaped bottom, or a double-arc shape, or a double-half-moon shape, or a double-U-shape; alternatively, the first annular expansion groove 8 is located in the middle of the second land 4, a cross-section of the first annular expansion groove 8 is in an arc shape, or a half-moon shape, or a U-shape having a half-moon shaped bottom, or a double-arc shape, or a double-half-moon shape, or a double-U-shape, and a surface of the first annular expansion groove 8 is intersected with the surface of the second land 4 to form an upper corner angle 81 and a lower corner angle 82 (sharp, without any chamfer or fillet). The surface of the second land 4 is intersected with the first compression ring groove 3 and the second compression ring groove 5, respectively, to form an upper land angle 41 and a lower land angle 42 (with a small chamfer).

Wherein, a ratio of the width of the first annular expansion groove 8 to the height of the second land 4 is less than 1.0, preferably, 0.45 to 0.80; and a ratio of the depth to the width of the first annular expansion groove 8 is less than 1.0, preferably, 0.3 to 0.5.

Further, a cross-section of the first annular expansion groove can be in a U-shape having a half-moon shaped bottom. The surface of the first annular expansion groove 8 having a U-shaped cross-section is intersected with the surface of the second land 4 to form a sharp corner edge (without any chamfer).

Wherein, a ratio of the depth to the width of the first annular expansion groove 8 having a U-shaped cross-section is less than 1.0, preferably, 0.5 to 0.8; and a ratio of the width of the first annular expansion groove 8 having a U-shaped cross-section to the height of the second land 4 is less than 1.0, preferably, 0.45 to 0.80.

In a case where an engine is running under a high cylinder pressure, the present invention further provides another engine piston. In addition to the piston structure described as above for an engine, a second annular expansion groove 9 can be also disposed on the periphery of the third land 6; a cross-section of the second annular expansion groove 9 is in an arc shape, or a half-moon shape, or a U-shape having a half-moon shaped bottom, or a double-arc shape, or a double-half-moon shape, or a double-U-shape; and the second annular expansion groove 9 is located in the middle of the third land 6, and a surface of the second annular expansion groove 9 is intersected with a surface of the third land 6 to form a sharp corner edge (without any chamfer).

In conclusion, in the engine piston of the present invention, a piston structure, together with a piston ring set and a cylinder bore wall both matched to the piston structure, forms a special crevice passage with a multistage throttling and expansion function. The crevice passage will generate high enough flow resistance in the compression, ignition and expansion processes of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The engine piston of the present invention can not only greatly and effectively reduce the intra-cylinder carbon deposition and the hydrocarbon emissions in the exhaust gas emissions of the engine, but also significantly improve the engine efficiency and the overall performance of the engine, so that the piston of the present invention is suitable for wide applications.

The protection scope of the present invention is not limited to each of embodiments described in this description. Any changes and replacements made on the basis of the scope of the present invention patent and of the description shall be included in the scope of the present invention patent.

1-10. (canceled)

11. A piston for an engine, comprising a piston body;
wherein, a top land, a first compression ring groove, a second land, a second compression ring groove, a third land, an oil ring groove are disposed in turn on the periphery of the piston body from top to bottom;
and more than one of annular expansion grooves are disposed on the periphery of the second land.

12. A piston for an engine, comprising a piston body;
wherein, a top land, a first compression ring groove, a second land, a second compression ring groove, a third land, an oil ring groove are disposed in turn on the periphery of the piston body from top to bottom;
at least one annular expansion groove is disposed on the periphery of the second land;
at least one annular expansion groove is further disposed on the periphery of the third land.

13. A piston for an engine, comprising a piston body;
wherein, a top land, a first compression ring groove, a second land, a second compression ring groove, a third land, an oil ring groove are disposed in turn on the periphery of the piston body from top to bottom;
and at least one of annular expansion grooves are disposed on the periphery of the third land.

14. The piston of claim 11, wherein the first compression ring groove and the second compression ring groove have equal or unequal depths; and the ratio of the depth of the first compression ring groove to the depth of the second compression ring groove is 0.6 to 0.65.

15. The piston of claim 11, wherein the cross-section of the annular expansion grooves is in an arc shape, or a half-moon shape, or a U-shape having a half-moon shaped bottom, or a double-arc shape, or a double-half-moon shape, or a double-U-shape.

16. The piston of claim 15, wherein the surface of the annular expansion groove is intersected with the surface of the corresponding second or third land to form an upper corner angle and a lower corner angle.

17. The piston of claim 11, wherein a ratio of the width of each annular expansion groove on the second land or a sum of widths of the annular expansion grooves to a height of a corresponding second land is 0.45 to 0.80.

18. The piston of claim 15, wherein
a ratio of the depth to the width of each annular expansion groove on the second land is 0.3 to 0.5;
for annular expansion grooves having a cross-section in a U-shape or a double-U-shape, a ratio of the depth to the width is 0.5 to 0.8.

19. The piston of claim 11, wherein
the first compression ring groove and the second compression ring groove have equal or unequal widths;
a ratio of the width of the first compression ring groove to the width of the second compression ring groove is 0.6 to 1.0.

20. The piston of claim 12, wherein,
the first compression ring groove and the second compression ring groove have equal or unequal depths;
a ratio of the depth of the first compression ring groove to the depth of the second compression ring groove is 0.6 to 0.65.

21. The piston of claim 12, wherein the cross-section of the annular expansion grooves is in an arc shape, or a half-moon shape, or a U-shape having a half-moon shaped bottom, or a double-arc shape, or a double-half-moon shape, or a double-U-shape.

22. The piston of claim 21, wherein the surface of each annular expansion groove is intersected with the surface of the corresponding second or third land to form an upper corner angle and a lower corner angle.

23. The piston of claim 12, wherein a ratio of the width of each annular expansion groove on the second land or the third land or a sum of widths of the annular expansion grooves to a height of a corresponding second or third land is 0.45 to 0.80.

24. The piston of claim 21, wherein
a ratio of the depth to the width of each annular expansion groove on the second land or the third land is 0.3 to 0.5;
for annular expansion grooves having a cross-section in a U-shape or a double-U-shape, a ratio of the depth to the width is 0.5 to 0.8.

25. The piston of claim 12, wherein
the first compression ring groove and the second compression ring groove have equal or unequal widths;
a ratio of the width of the first compression ring groove to the width of the second compression ring groove is 0.6 to 1.0.

26. The piston of claim 13, wherein the first compression ring groove and the second compression ring groove have equal or unequal depths; and the ratio of the depth of the first compression ring groove to the depth of the second compression ring groove is 0.6 to 0.65.

27. The piston of claim 13, wherein at least one of annular expansion grooves are disposed on the periphery of the third land, and the cross-section of the annular expansion grooves is in an arc shape, or a half-moon shape, or a U-shape having a half-moon shaped bottom, or a double-arc shape, or a double-half-moon shape, or a double-U-shape.

28. The piston of claim 27, wherein the surface of the annular expansion groove is intersected with the surface of the corresponding third land to form an upper corner angle and a lower corner angle.

29. The piston of claim 13, wherein a ratio of the width of each annular expansion groove or a sum of widths of the annular expansion grooves to a height of a corresponding land is 0.45 to 0.80.

30. The piston of claim 27, wherein
a ratio of the depth to the width of each annular expansion groove on the third land is 0.3 to 0.5;
for annular expansion grooves having a cross-section in a U-shape or a double-U-shape, a ratio of the depth to the width is 0.5 to 0.8.
